(19) United States
(12) Patent Application Publication
(10) Pub. No.: US 2024/0394551 A1
(43) Pub. Date: Nov. 28, 2024

(54) FINE-TUNING A NEURAL NETWORK MODEL

(71) Applicant: NTT Research, Inc., Sunnyvale, CA (US)

(72) Inventors: Hidenori TANAKA, Belmont, MA (US); Ekdeep Singh LUBANA, Ann Arbor, MI (US)

(73) Assignees: NTT Research, Inc., Sunnyvale, CA (US); President and Fellows of Harvard College, Cambridge, MA (US)

(21) Appl. No.: 18/670,519

(22) Filed: May 21, 2024

Related U.S. Application Data
(60) Provisional application No. 63/504,058, filed on May 24, 2023.

(51) Int. Cl. G06N 3/09

(52) U.S. Cl. CPC G06N 3/09

(57) ABSTRACT

Computer-implemented system and method are disclosed herein for fine tuning a neural network model. The method includes seeking, in a loss landscape, a nonlinear path with a loss barrier from a loss function associated with a first neural network model. The method further includes altering, in response to said seeking, one or more mechanisms of the first neural network model to induce a second neural network model.

### CROSS-REFERENCE TO RELATED APPLICATION[S]

This application claims priority to U.S. Provisional Patent Application Ser. No. 63/504,058, filed on May 24, 2023, which is incorporated herein by reference in its entirety.

### FIELD

The present disclosure relates to neural networks and, more particularly, to fine-tuning neural network models.

### BACKGROUND

A number of studies have shown that deep neural networks (DNNs) tend to suffer from various robustness problems, learning representations that fail to generalize well beyond the given training distribution. This lack of robustness is generally a consequence of models' learning mechanisms that rely on spurious attributes in the training data for making their predictions. Spurious attributes are, for a lack of a better term, “false” or unreliable cues that may not be very robust. As the studies have further shown, such attributes-even if not perfectly predictive-tend to be simpler to represent according to the model's inductive biases and commonly emerge due to sampling biases and hidden confounders in static datasets.

For example, some studies have shown that in most vision datasets, backgrounds are correlated with object categories-a sampling bias. Consequently, a model can learn to predict the correct category of an object by learning mechanisms to identify either its background or its shape; however, only models that rely on shape are likely to generalize robustly.

Indeed, some studies have shown that using different datasets for a task, standard training pipelines can induce models that use entirely distinct mechanisms for making their predictions, performing equally well in-distribution but vastly differently out-of-distribution. Recent works on improving neural network robustness thus advocate a need for modeling the causal mechanisms underlying the data-generating process, promoting representations invariant to spurious attributes. That is, to seek models that do not rely on spurious attributes (e.g., the background of an object to be identified) but instead rely on more “robust” attributes (e.g., the shape of the object to be identified).

### BRIEF DESCRIPTION OF THE DRAWINGS

FIG. 1A illustrates an example loss path of a neural network when one or more parameters of the neural network are adjusted;

FIG. 1B illustrates another example loss path of the neural network when one or more parameters are adjusted;

FIG. 1C illustrates another example loss path of the neural network when one or more parameters are adjusted;

FIG. 2 is a high-level block diagram of an example computing device in accordance with some embodiments; and; and

FIG. 3 is a flow chart of an example process 300 for fine-tuning a neural network model in accordance with some embodiments

### DETAILED DESCRIPTION

According to various embodiments of the present disclosure, systems and computer-implemented methods are disclosed herein that may fine-tune a neural network (NN) model that relies on spurious attributes to produce/induce a robust NN model that does not rely on such spurious attributes, but instead, relies on “robust” attributes that may provide better or more accurate predictions. Note that in the following description, and for purposes of succinctness, a NN model or models will be referred to simply as “model” or “models.” A model, for purposes of the following, is a neural network with a specific set of parameters (e.g., weights and biases). For the embodiments, the systems and computer-implemented methods may employ a technique, referred to herein as a Connectivity-Based Fine-tunning (CBFT), that exploits the lack of linear connectivity between mechanistically dissimilar models to induce robust models. That is, it has been determined that a first model that relies on spurious attributes will be mechanistically dissimilar from a more robust second model that does not rely on the spurious attributes and will not be linearly connected with the first model in the loss landscape as will be described in greater detail herein.

To fine-tune a first model that relies on spurious attributes to induce a more robust second model that does not rely on the spurious attributes, in some embodiments, a first set of parameters (e.g., weights and biases) of the first model may be iteratively adjusted to eventually produce the second model with a second set of parameters that may be more robust in accordance with various embodiments. Of course, because a model can have numerous parameters, which, in some cases, may include thousands or millions of parameters, there are many combinations of parameter adjustments that may be possible. For purposes of the following description, a model that relies on spurious attributes may be referred to herein as a biased model, while a robust model that does not rely on the spurious attributes will be referred to herein as an unbiased model.

To make the fine-tuning of the biased model more efficient to induce the unbiased model, the CBFT method, in accordance with various embodiments, exploits the non-linear relationship in the loss landscape (e.g., error landscape) between a biased model that relies on spurious attributes and an unbiased model that does not rely on the spurious attributes. To understand the CBFT method for fine-tuning a model, certain concepts and relationships will now be introduced. These concepts and relationships are described in a publication authored by Ekdeep Singh Lubana, Eric J. Bigelow, Robert Dick, David Krueger, and Hidenori Tanaka, entitled Mechanistic Mode Connectivity, published Nov. 15, 2022, https://ntt-research.com/wp-content/uploads/2023/02/Mechanistic-Mode-Connectivity.pdf, which is incorporated herein by reference in its entirety.

To understand the various concepts and features of the CBFT computer-implemented methods, we first introduce the concept of mechanistic similarity. Two models are considered mechanistically similar when they rely on the same input attributes for making their predictions. Specifically, two models may be referred to as mechanistically similar if they exhibit invariance to the same attributes of an input but may otherwise produce different representations for it. That is, two models are mechanistically similar if they predict similarly when the same input is provided. On the other hand, if two models, when fed with the same input dataset, produce different outputs (e.g., different predictions), then they are mechanistically dissimilar. For instance, a biased model that relies on spurious attributes will be mechanistically dissimilar to an unbiased model that does not rely on spurious attributes and, thus, employs different mechanisms than those employed by the biased model.

As noted above, the CBFT computer-implemented method disclosed herein may more efficiently fine-tune a first model that relies on spurious attributes to induce a robust second model that does not rely on the spurious attributes by mechanistic fine-tuning the first model to alter its mechanisms, i.e., to learn different invariances. That is, one conventional approach to fine-tune a model that relies on spurious attributes is to train the model by curating a large, clean dataset and training the model from scratch, which tends to be expensive and, in many cases, impractical and inefficient. In contrast, the CBFT method takes advantage of the mechanistic dissimilarity and the non-linear path in the associated loss landscape between the loss function (herein after “loss”) of a biased model, and the loss of an unbiased model to more efficiently fine-tune the biased model and to induce the unbiased model.

In general, models that rely on spurious attributes and those robust models that don't rely on spurious attributes are neural network minimizers (herein simply “minimizers”) with relatively little or no loss. For example, biased models that rely on spurious attributes may have relatively low loss, but unbiased models that rely on robust attributes may have no loss. Minimizers have minimal or no loss so that their losses are local minimums in the loss landscape. Typically, biased models that rely on spurious attributes and unbiased models that rely on robust attributes are minimizers with minima losses on the loss landscape.

According to various embodiments, to fine-tune a first model that relies on spurious attributes to induce a second model that is more robust and that does not rely on the spurious attributes, the parameters of the first model may be iteratively adjusted to seek a non-linear path in the associated loss landscape from the loss function (herein simply “loss”) of the first model to the loss of the second model, where loss along the nonlinear path that is sought increases first before it decreases when moving from the loss associated with the first model to the loss associated with the second model in the loss landscape as will be further discussed below. Note that minimizers, as used herein, are in reference to models and their parameters that produce no or relatively little loss, where their respective losses are local minima in their loss landscape.

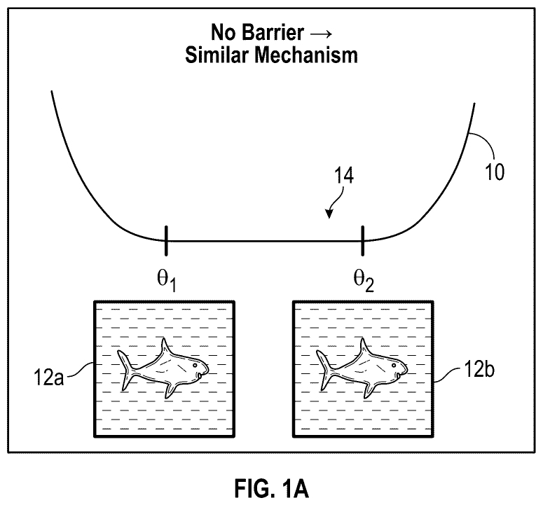

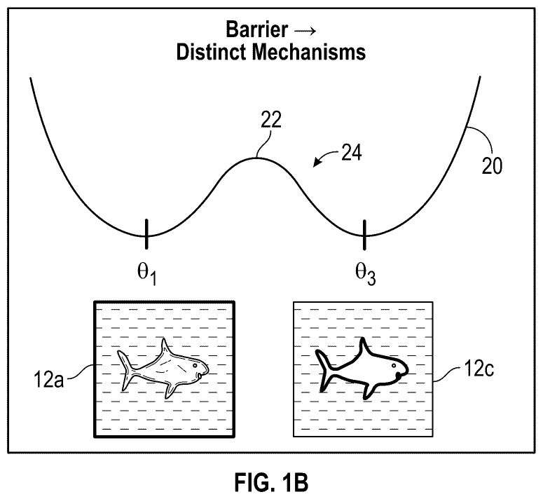

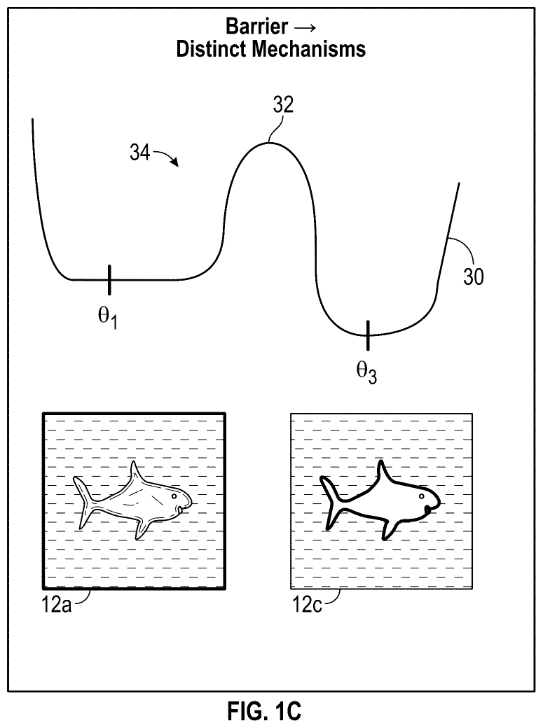

To facilitate understanding of various concepts to be discussed herein, FIGS. 1A, 1B, and 1C are provided showing loss functions (hereinafter simply “losses”) along a loss path associated with different neural network models that have different parameters. Specifically, FIGS. 1A, 1B, and 1C illustrate losses associated with a neural network when the parameters of the neural network are adjusted to form different neural network models. That is, each time at least a subset of the parameters of a neural network is changed, a new model is formed/induced. Each model (e.g., the set of parameters of the model) will be associated with a loss function (or simply “loss”). The curves shown in FIGS. 1A, 1B, and IC essentially represent simplified loss paths when selective parameters of the neural network are adjusted. Note that since an actual neural network will have thousands, and perhaps millions of parameters, an accurate loss or error landscape will have thousands or millions of dimensions, with thousands or millions of loss paths going in all directions in the multi-dimensional landscape, which cannot be accurately depicted in a two or three-dimensional rendition of the loss landscape (e.g., error landscape). Thus, FIGS. 1A, 1B, and 1C depict selective example loss paths in a loss landscape.

In the following, the symbol θₙ may represent, depending on context, a specific NN model and its associated parameters or the loss (i.e., loss function) associated with the NN model. For instance, in FIGS. 1A, 1B, and 1C, the symbols θ₁, θ₁, and θ₃, represent the losses associated with models that may be referred to as model θ₁, model θ₁, and model θ₃ that may each be associated with different parameters (e.g., parameters θ₁, parameters θ₁, and parameters θ₃). That is, at least a subset of parameters θ₁, parameters θ₁, and parameters θ₃ will be different.

Turning particularly now to FIG. 1A, which illustrates different losses associated with a neural network for recognizing or identifying a fish in an image when at least a subset of the parameters of the neural network are adjusted to produce different models resulting in different losses along the loss path illustrated in FIG. 1A. That is, FIG. 1A shows an example loss path 10 of the neural network designed to identify a fish in an image. In FIG. 1A, θ₁ represents a set of parameters for a biased model (e.g., a model that relies on spurious attributes), as well as the loss function (or simply “loss”) associated with the biased model. In this example, model θ₁ (or the set of parameters associated with model θ₁) looks at the background (e.g., spurious attribute) of image 12a, which, in this case, is the blue color (not shown in FIG. 1A) of the water in the background to determine/identify a fish. Note that the outer border of image 12a is bolded indicating that the background (e.g., the blue color of the water surrounding the fish) is the basis for identifying the fish by the biased model θ₁.

In FIG. 1A, θ₂ represents a second model with a second set of parameters, as well as the loss associated with the second model. In FIG. 1A, the losses associated with θ₁ and θ₂ are linearly connected along the loss path 10. That is, the losses associated with model θ₁ and model θ₂ are connected via a linear path 14 between θ₁ and θ₂ (note that linear path 14 is just a segment of loss path 10 between θ₁ and θ₂). Thus, the models associated with θ₁ and θ₂ are linearly connected in the loss landscape. In this case, the models associated with θ₁ and θ₂ both rely on the same or similar mechanism (e.g., spurious attributes in the form of the blue color of the background water) to identify the fish. Because both models rely on the same decision-making mechanism (e.g., background) for making prediction/identification, the loss path (e.g., linear path 14) between the two models θ₁ and θ₂ does not increase or decrease but instead stays the same. As a result, there is no loss barrier 22 between θ₁ and θ₂, as will be illustrated in FIG. 1B. That is, a loss barrier 22 is a segment of a loss path between losses of two minimizers (e.g. loss associated with two NN model minimizers) where the loss or error increases before decreasing. More particularly, a loss barrier 22 is a loss bump or mound located along, for example, a loss path 24 between losses of two minimizers (e.g., the model θ₁ and a model θ₃) as will be illustrated and described with respect to FIG. 1B.

FIG. 1B illustrates another example loss path 20 for the neural network for identifying a fish in an image. In this example, θ₁ again represents the same biased model (as well as its parameters) for identifying a fish that relies on a spurious attribute (e.g., the blue color of the background water of the image) to predict/identify a fish. In FIG. 1B, θ₁ again may also represent the loss associated with the biased model θ₁. In contrast, θ₃ represents another model (and its set of parameters), as well as its associated loss, where the model θ₃ is an unbiased model for identifying a fish that does not rely on a spurious attribute to identify the fish, but instead, relies on a robust attribute (e.g., the shape of a fish) to identify a fish. Consequently, in FIG. 1B, the shape of the fish in image 12c is bolded (e.g., the model associated with θ₃ uses the shape of the fish as the basis of deciding that the object in the image is, in fact, a fish) while the outline of the image 12c is not bolded as was the case in image 12a. Because the models that are associated with θ1 and θ₃ are mechanistically different, they are not linearly connected in the loss landscape, but instead, connected by a nonlinear path 24, which is part of the overall loss path 20 illustrated in FIG. 1B. Along the nonlinear path 24 between the loss associated with model θ₁ and loss associated with model θ₃ is a loss barrier 22, where the loss barrier 22 along the nonlinear path 24 can be characterized as a portion of the nonlinear path 24 where the loss increases before decreasing when moving between losses of the two minimizer models (e.g. models, θ₁ and θ₃). Note that although in FIG. 1B the loss associated with model θ₁, which is a biased model, appears to be the same as the loss associated with model θ₃, which is an unbiased model, in various embodiments, the loss associated with model θ₃ may be lower than the loss associated θ₁. This would be expected when model θ₃ is an unbiased and robust model and when the model θ₁ is a biased mode relying on a spurious attribute as will be illustrated in FIG. 1C.

FIG. 1C illustrates another example loss path 30 that links the loss associated with model θ₁ with the loss associated with model θ₃. Note, however, that the profile of the loss path 30 is different from the loss path 20 of FIG. 1C. Further, in this case, the loss associated with model θ₃, which is an unbiased model, is noticeably lower than the loss associated with model θ₁, which is a biased model. As in FIG. 1B, the portion of the loss path 30 between θ₁ and θ₃ is nonlinear. That is, the nonlinear path 34 between θ₁ and θ₃ includes a loss barrier 32, where the loss increases before decreasing when moving along the nonlinear path 34 when moving from the loss associated with model θ₁ to the loss associated with model θ₃ (and vice versa). As illustrated in FIG. 1C, the profile of the nonlinear path 34 between θ₁ and θ₃ is different from the profile of the nonlinear path 24 in FIG. 1B. That is, in FIG. 1B, the nonlinear path 24 is entirely or substantially embodied by the loss barrier 22 such that the loss immediately increases along the nonlinear path 24 when moving from θ₁ and towards θ₃ along the nonlinear path 24 before the loss decreases. In contrast, the loss associated with nonlinear path 34 in FIG. 1C does not immediately increase along the nonlinear path 34 when moving from θ₁ and towards θ₃ along the nonlinear path 34 before the loss decreases. Instead, the loss in the nonlinear path 34 remains steady at least for a while before increasing as part of the rising slope of the loss barrier 32.

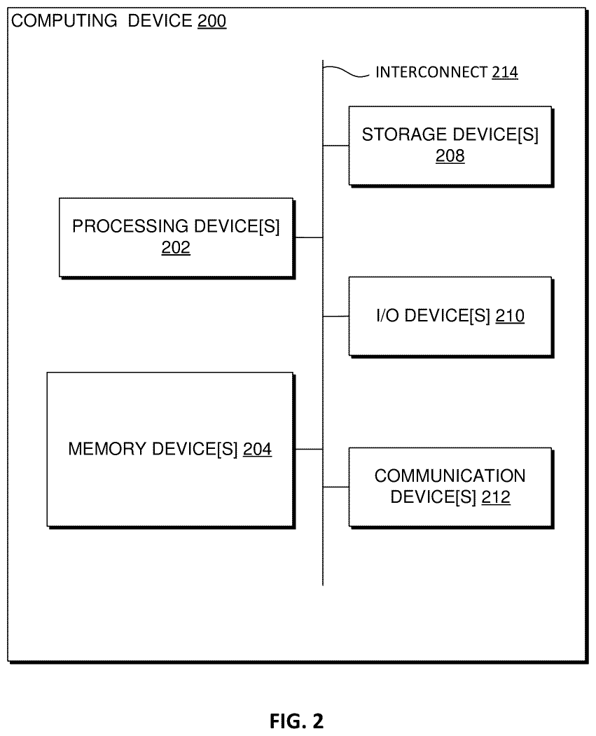

FIG. 2 is a high-level block diagram of an example computing device 200 in accordance with some example embodiments. In various embodiments, the computing device 200 may be used to implement one or more operations of the computer-implemented CBFT method for fine-turning a neural network model described above. In some alternative embodiments, a plurality of computing devices 200 (e.g., cloud implementation) may implement the CBFT method for fine-turning a neural network model described herein. Note that for purposes of the following description references to a computing system may be in reference to one or more computing devices 200 of FIG. 2.

As illustrated, the computing device 200 may include one or more processing devices 202, one or more memory devices 204, one or more storage devices 208, one or more input/output (I/O) devices 210, and one or more communication devices 212, all coupled together via an interconnect 214. The one or more memory devices 204 may store computer-readable instructions, which may also be stored in one or more storage devices 208, for executing, among other things, the various operations of, for example, the CBFT methods described herein. For example, the processes and logic flow to be described herein can be performed by one or more processing devices 202 executing the computer-readable instructions stored in the memory device[s] 204 and/or the storage device[s] 208.

The interconnect 214 may be or include one or more conductive traces, buses, point-to-point connections, controllers, adapters, and/or other connection devices. The one or more processing devices 202 may include, for example, one or more processors, digital signal processors (DSPs), controllers, field programmable gate array (FPGA), application specific integrated circuit (ASIC), or the like, or any combination thereof. The one or more memory devices 204 may include one or more physical storage devices, which may be in the form of random access memory (RAM), read-only memory (ROM), flash memory, miniature hard disk drive, or other suitable type of storage device, or a combination of such devices. The one or more storage devices 208 may include one or more hard drives, digital versatile disks (DVDs), flash memories, or the like. As noted above, each of the memory devices 204 and/or storage devices 208 may store, individually or collectively, data and instructions that configure the one or more processing devices 202 to execute operations to implement the processes and operations described herein.

The one or more communication devices 212 may include, for example, a network interface card (NIC), an Ethernet adapter, cable modem, Wi-Fi adapter, cellular transceiver, baseband processor, or the like, or a combination thereof. The one or more I/O devices 210 may include, for example, a display (which may be a touch screen display), audio speaker, keyboard, mouse, or other pointing device, microphone, camera, and so forth. Note that in the case of the computing device 200 being a server, or other devices that do not need to directly communicate with a user, the computing device 200 may not include an I/O device 210.

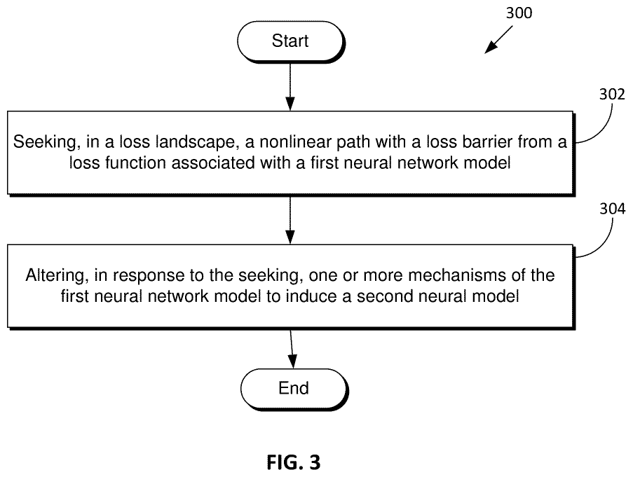

FIG. 3 is a flow chart of an example process 300 for fine-tuning a neural network model in accordance with various embodiments. In some embodiments, the operations illustrated in FIG. 3 may be performed by a computer system, such as one or more computing devices 200 illustrated in FIG. 2. For case of illustration and to facilitate understanding of process 300, the following discussion of process 300 may reference some of the concepts introduced with respect to FIGS. 1A, 1B and IC, as well as the computing device 200 of FIG. 2. However, those of ordinary skill in the art will recognize that process 300 may be implemented using systems and concepts other than those illustrated and introduced in FIGS. 1A, 1B, 1C, and 2.

The example process 300 may begin at 302 when a nonlinear path with a loss barrier from a loss function associated with a first neural network model is sought in a loss landscape. For instance, a computing system (e.g., one or more computing devices 200 of FIG. 2) seeking, in a loss landscape, a nonlinear path with a loss barrier 22 or 32 from a loss function associated with a first neural network model (e.g., loss associated with model θ₁ of FIG. 1C). In other words, seeking a nonlinear loss path that originates or passes through the loss associated with, for example, a first neural network model such as model θ₁ of FIG. 1C In some embodiments, and as will be further described herein, the seeking of a nonlinear path may entail seeking a nonlinear path where the loss increases before decreasing as you move along the nonlinear path and away from the loss function associated with a first neural network model. In some cases, this may involve, for example, looking at different loss paths that pass through or originate from the loss function associated with the first neural network model and seeing which of the loss paths has increasing loss rather than decreasing loss (e.g., the loss gradient is increasing and not decreasing.

At 304, one or more mechanisms of the first neural network model are altered in response to the seeking to induce the second neural network model. For example, the computing system altering, in response to the seeking, one or more mechanisms (e.g., adjusting weights and/or biases) of the first neural network model (e.g., the model θ₁ associated with loss θ₁ of FIG. 1B or 1C) to induce the second neural network model (e.g., the model θ₃ associated with loss θ₃ of FIG. 1B or 1C) that does not rely on the same mechanisms as model θ₁. In various embodiments, operations 302 and 304 may be iteratively performed to find a nonlinear path for inducing the second neural network. In various embodiments, each mechanism to be adjusted may be iteratively adjusted (e.g., adjusted multiple times) to induce the second neural network model.

In some embodiments, the first neural network model is a first minimizer associated with a first local minimum in the loss landscape. For example, the first neural network model (e.g., the model θ₁ associated with loss θ₁ of FIG. 1C) is a first NN model minimizer that may have relatively low loss in the respective loss landscape.

In some embodiments, the second neural network model is a second minimizer associated with a second local minimum in the loss landscape. For example, the second neural network model (e.g., the model θ₃ associated with loss θ₃ of FIG. 1C) is a first NN model minimizer that may have relatively low or no loss in the respective loss landscape (e.g., a second NNN model with a second local loss minimum in the loss landscape where loss increases, at least temporarily, when moving away from the second local minimum on the loss landscape). In various embodiments, the loss associated with the second minimizer (e.g., the second neural network model) may be lower than the loss associated with the first minimizer (e.g., the first neural network model).

In some embodiments, the seeking, in a loss landscape, a nonlinear path with a loss barrier from a loss function associated with a first neural network model is by seeking, in the loss landscape, a nonlinear path from the loss function associated with the first neural network model that initially increases in loss before decreasing in loss. For example, the computing system (e.g., one or more computing devices 200 of FIG. 2) seeking, in the loss landscape, a nonlinear path 32 that passes or originates from the loss function (e.g., the loss θ₁ associated with model θ₁) associated with the first neural network model (e.g., model θ₁) that initially increases in loss before decreasing in loss as characterized by, for example, a loss barrier 32 (see FIG. 2C). Note that to determine whether a nonlinear path increases in loss, in some embodiments, each time some of the parameters of the neural network are adjusted to generate a new model with a new loss (e.g., loss function) in the loss landscape or path, the gradient or the slope associated with the new loss function in the loss landscape or loss path may be checked to determine whether the loss is increasing.

In some embodiments, the seeking, in a loss landscape, a nonlinear path with a loss barrier from a loss function associated with a first neural network model includes seeking a nonlinear path from the loss function associated with a first neural network model with a loss barrier at or near center of the nonlinear path between the loss function associated with the first neural network model and the loss function associated with the second neural network model in the loss landscape. For example, the computing system (e.g., one or more computing devices 200 of FIG. 2) seeking a nonlinear path 24 (see FIG. 1B) from the loss function (e.g., loss associated with model θ₁) associated with a first neural network model (e.g., model θ₁) with a loss barrier 22 at or near center of the nonlinear path 24 between the loss function associated with the first neural network model (e.g., model θ₁) and the loss function associated with the second neural network model in the loss landscape (e.g., model θ₃)—see FIG. 1B.

In some embodiments, the first neural network model is a pre-trained model that relies on one or more spurious attributes. For instance, the model θ₁ referenced with respect to FIGS. 1B and 1C being a pre-trained model that relies on one or more spurious attributes (e.g., the background of the object to be identified such as a fish).

In some embodiments, the altering, in response to said seeking, one or more mechanisms of the first neural network model to induce a second neural network model is by altering one or more mechanisms of the first neural network model to induce a second neural network model that is mechanistically dissimilar to the first neural network model. For example, the computing system (e.g., one or more computing devices 200 of FIG. 2) altering, in response to said seeking, one or more mechanisms of the first neural network model (e.g., model θ₁ of FIG. 1C) to induce a second neural network model (e.g., model θ₃ of FIG. 1C) by altering one or more mechanisms of the first neural network model (e.g., model θ₁ of FIG. 1C) to induce a second neural network model (e.g., model θ₃ of FIG. 1C) that is mechanistically dissimilar to the first neural network model (e.g., model θ₁ of FIG. 1C).

In some embodiments, the second neural network model does not rely on the one more spurious attributes. For instance, the model θ₃ referenced with respect to FIGS. 1B and 1C does not rely on one or more spurious attributes but instead rely on one or more robust attributes (e.g., the shape of a visual object such as a fish to be identified).

In some embodiments, the altering, in response to said seeking, one or more mechanisms of the first neural network model to induce a second neural network model includes altering the one or more mechanisms of the first neural network model to induce a second neural network model that is associated with a loss function that is less than the loss function associated with the first neural network model. For example, the computing system (e.g., one or more computing devices 200 of FIG. 2) altering the one or more mechanisms of the first neural network model (e.g., the model θ₁ referenced with respect to FIGS. 1B and 1C) to induce a second neural network model (e.g., the model θ₃ referenced with respect to FIGS. 1B and 1C) that is associated with a loss function θ₃ (e.g., zero loss) that is less than the loss function θ₁ associated with the first neural network model θ₁.

In some embodiments, the first neural network model includes a first set of parameters and the second neural network model includes a second set of parameters that are at least partly different from the first set of parameters. For example, the model θ₁ referenced with respect to FIGS. 1B and 1C includes a first set of parameters θ₁ (e.g., weights and biases) and the model θ₃ referenced with respect to FIGS. 1B and 1C includes a second set of parameters θ₃ (e.g., weights and biases) that are at least partly different from the first set of parameters.

In some embodiments, the altering of one or more mechanisms of the first neural network model includes altering the one or more parameters of the first set of parameters of the first neural network model to move to a region in the loss landscape that does not exhibit linear mode connectivity to the first set of parameters. For example, the computing system (e.g., one or more computing devices 200 of FIG. 2) altering the one or more parameters of the first set of parameters of the first neural network model (e.g., the model θ₁ referenced with respect to FIGS. 1B and 1C) to move to a region in the loss landscape (e.g., in FIG. 1C, the segment of loss path 30 to the right of loss barrier 32) that does not exhibit linear mode connectivity to the first set of parameters of the first neural network model (e.g., model θ₁).

In some embodiments, the altering, in response to said seeking, one or more mechanisms of the first neural network model to induce a second neural network model includes adjusting one or more parameters of the first set of parameters of the first neural network. For example, the computing system (e.g., one or more computing devices 200 of FIG. 2) altering the one or more mechanisms of the first neural network model by adjusting one or more parameters (e.g., weights and/or biases) of the first set of parameters among, for example, many parameters of the first neural network (e.g., the model θ₁ referenced with respect to FIGS. 1B and 1C).

In some embodiments, the adjusting of one or more parameters of the first set of parameters of the first neural network model includes adjusting one or more weights of the first neural network model. For example, the computing system (e.g., one or more computing devices 200 of FIG. 2) adjusting one or more parameters of the first set of parameters of the first neural network model by adjusting (e.g., increasing and/or decreasing) one or more weights of the first neural network model (e.g., the model θ₁ referenced with respect to FIGS. 1B and 1C).

In the same or alternative embodiments, the adjusting of one or more parameters of the first set of parameters of the first neural network model includes adjusting one or more biases of the first neural network model. For example, the computing system (e.g., one or more computing devices 200 of FIG. 2) adjusting one or more parameters of the first set of parameters of the first neural network model includes adjusting (e.g., increasing and/or decreasing) one or more biases of the first neural network model (e.g., the model θ₁ referenced with respect to FIGS. 1B and 1C).

In some embodiments, the adjusting of one or more parameters of the first set of parameters of the first neural network model includes adjusting the one or more parameters of the first set of parameters of the first neural network iteratively in response to said seeking. For example, the computing system (e.g., one or more computing devices 200 of FIG. 2) adjusting the one or more parameters of the first set of parameters (e.g., weights and biases) of the first neural network (e.g., the model θ₁ referenced with respect to FIGS. 1B and 1C) iteratively in response to said seeking. That is, performing both the seeking and adjusting operations iteratively.

In some embodiments, the nonlinear path is sought, at least in part, by seeking a set of parameters for the neural network that is associated with a loss function that is greater than the loss function of the first neural network model. For example, the computing system (e.g., one or more computing devices 200 of FIG. 2) seeking a set of parameters for the neural network that is associated with a loss function that is greater than the loss function of the first neural network model (e.g., the model θ₁ referenced with respect to FIGS. 1B and 1C). That is, unlike conventional optimization techniques for fine-tuning models that seek neural network parameters that result in reduced loss (e.g., loss function) relative to the loss of the neural network model being fine-turned, the disclosed CBFT method first seeks neural network parameters that increase loss before seeking neural network parameters that decrease loss.

In various embodiments, the seeking and the altering of process 300 are iteratively performed as previously alluded to.

In some embodiments, process 300 may run alternating minimization of the following losses:

$${ℒ}_{1} ( θ ) = {argmin}_{\text{?}} 𝔼 \text{?} \vert {λ}_{1} - {ℒ}_{CE} ( f ( Dc ; γ \text{?} ( t ) ) , 𝓎 ) \vert \qquad ( i )$$

$${ℒ}_{2} ( θ ) = {argmin}_{θ} {ℒ}_{CE} ( f ( {𝒟}_{NC} ; θ ) ; 𝓎 ) + \frac{{λ}_{2}}{K} {\sum }_{k = 1}^{K} ‖ {𝔼}_{x ∈ {𝒟}_{C}^{k}} ( {f}_{r} ( x ; θ ) ) - {{𝔼}_{\overline{x} ∈ 𝒟}}_{NC}^{k} ( {f}_{r} ( \tilde{x} ; θ ) ) ‖ \qquad ( ii )$$

$$\text{?} \text{indicates text missing or illegible when filed}$$

and wherein
D denotes a dataset;
Dⁱ denotes a subset of a dataset corresponding to samples that belong to the i^{th} class in a K-classification problem;
D_{NC} denotes a minimal dataset that does not contain attribute C that the mechanism targeted for alternation in model f(., θc) tries to identify;
L_{CE} denotes cross-entropy loss;
γ_{θ→θc} (t) denotes the linear path between θ, which is a second set of parameters of the second neural network model that does not relay on one or more spurious attributes and θc, which is a first set of parameters of the first neural network model that relies on the one or more spurious attributes; and
fᵣ(x; θ) denotes representation for an input x.

In various embodiments, the above-described method may be implemented by a computing system, which may include one or more computing devices (e.g., one or more desktop computers, laptop computers, mobile devices, servers, and/or the like), that include one or more processors, and a memory that contains instructions that when executed by the one or more processors may cause the computing system to perform the above-described method. In some embodiments, the instructions may be stored in one or more non-transitory computer-readable storage media.

In various embodiments, the above-described method may be performed when one or more processors execute instructions stored in one or more non-transitory computer-readable storage media.

After reviewing the present disclosure, an individual of ordinary skill in the art will immediately appreciate that some details and features can be added, removed and/or changed without deviating from the spirit of the invention. Reference throughout this specification to “one embodiment,” “an embodiment,” “additional embodiment(s)” or “some embodiments,” means that a particular feature, structure or characteristic described in connection with the embodiment(s) is included in at least one or some embodiment(s), but not necessarily all embodiments, such that the references do not necessarily refer to the same embodiment(s). Furthermore, the particular features, steps, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method to fine-tune a neural network model, comprising:
seeking, in a loss landscape, a nonlinear path with a loss barrier from a loss function associated with a first neural network model; and
altering, in response to said seeking, one or more mechanisms of the first neural network model to induce a second neural network model.

2. The computer-implemented method of claim 1, wherein the first neural network model is a first minimizer associated with a first local minimum in the loss landscape.

3. The computer-implemented method of claim 2, wherein the second neural network model is a second minimizer associated with a second local minimum in the loss landscape.

4. The computer-implemented method of claim 1, wherein seeking, in a loss landscape, a nonlinear path with a loss barrier from a loss function associated with a first neural network model is by seeking, in the loss landscape, a nonlinear path from the loss function associated with the first neural network model that initially increases in loss before decreasing in loss.

5. The computer-implemented method of claim 1, wherein seeking, in a loss landscape, a nonlinear path with a loss barrier from a loss function associated with a first neural network model includes seeking a nonlinear path from the loss function associated with a first neural network model with a loss barrier at or near center of the nonlinear path between the loss function associated with the first neural network model and the loss function associated with the second neural network model in the loss landscape.

6. The computer-implemented method of claim 1, wherein the first neural network model is a pre-trained model that relies on one or more spurious attributes.

7. The computer-implemented method of claim 6, wherein the second neural network model does not rely on the one more spurious attributes.

8. The computer-implemented method of claim 1, wherein altering, in response to said seeking, one or more mechanisms of the first neural network model to induce a second neural network model is by altering one or more mechanisms of the first neural network model to induce a second neural network model that is mechanistically dissimilar to the first neural network model.

9. The computer-implemented method of claim 1, wherein altering, in response to said seeking, one or more mechanisms of the first neural network model to induce a second neural network model includes altering the one or more mechanisms of the first neural network model to induce a second neural network model that is associated with a loss function that is less than the loss function associated with the first neural network model.

10. The computer-implemented method of claim 1, wherein the first neural network model includes a first set of parameters and the second neural network model includes a second set of parameters that are at least partly different from the first set of parameters.

11. The computer-implemented method of claim 10, wherein the altering of one or more mechanisms of the first neural network model includes altering the one or more parameters of the first set of parameters of the first neural network model to move to a region in the loss landscape that does not exhibit linear mode connectivity to the first set of parameters.

12. The computer-implemented method of claim 10, wherein altering, in response to said seeking, one or more mechanisms of the first neural network model to induce a second neural network model includes adjusting one or more parameters of the first set of parameters of the first neural network.

13. The computer-implemented method of claim 12, wherein adjusting one or more parameters of the first set of parameters of the first neural network model includes adjusting one or more weights of the first neural network model.

14. The computer-implemented method of claim 13, wherein adjusting one or more parameters of the first set of parameters of the first neural network model includes adjusting one or more biases of the first neural network model.

15. The computer-implemented method of claim 12, wherein adjusting one or more parameters of the first set of parameters of the first neural network model includes adjusting the one or more parameters of the first set of parameters of the first neural network iteratively in response to said seeking.

16. The computer-implemented method of claim 10, wherein the nonlinear path is sought, at least in part, by seeking a set of parameters for the neural network that is associated with a loss function that is greater than the loss function of the first neural network model.

17. The computer-implemented method of claim 1, wherein the seeking and the altering are iteratively performed.

18. The computer-implemented method of claim 1, where the method includes running alternating minimization of the following losses:
$${ℒ}_{1} ( θ ) = {argmin}_{\text{?}} 𝔼 \text{?} \vert {λ}_{1} - {ℒ}_{CE} ( f ( Dc ; γ \text{?} ( t ) ) , 𝓎 ) \vert \qquad ( i )$$
$${ℒ}_{2} ( θ ) = {argmin}_{θ} {ℒ}_{CE} ( f ( {𝒟}_{NC} ; θ ) ; 𝓎 ) + \frac{{λ}_{2}}{K} {\sum }_{k = 1}^{K} ‖ {𝔼}_{x ∈ {𝒟}_{C}^{k}} ( {f}_{r} ( x ; θ ) ) - {{𝔼}_{\overline{x} ∈ 𝒟}}_{NC}^{k} ( {f}_{r} ( \tilde{x} ; θ ) ) ‖ \qquad ( ii )$$
$$\text{?} \text{indicates text missing or illegible when filed}$$
and wherein
D denotes a dataset;
Dⁱ denotes a subset of a dataset corresponding to samples that belong to the i^{th} class in a K-classification problem;
D_{NC} denotes a minimal dataset that does not contain attribute C that the mechanism targeted for alternation in model f(., θc) tries to identify;
L_{CE} denotes cross-entropy loss;
γ_{θ→θc} (t) denotes the linear path between θ, which is a second set of parameters of the second neural network model that does not relay on one or more spurious attributes and θ_{C}, which is a first set of parameters of the first neural network model that relies on the one or more spurious attributes; and
fᵣ(x; θ) denotes representation for an input x.

19. One or more non-transitory computer-readable storage media including instructions that, when executed by one or more processors, cause the one or more processors to perform the steps of:
seek, in a loss landscape, a nonlinear path with a loss barrier from a loss function associated with a first neural network model; and
alter, in response to said seeking, one or more mechanisms of the first neural network model to induce a second neural network model.

20. A computing system, comprising:
one or more processors; and
memory containing instructions that, when executed by the one or more processors, cause the computing system to:
seek, in a loss landscape, a nonlinear path with a loss barrier from a loss function associated with a first neural network model; and
alter, in response to said seeking, one or more mechanisms of the first neural network model to induce a second neural network model.
